(19) United States
(12) Patent Application Publication
(10) Pub. No.: US 2020/0250628 A1
(43) Pub. Date: Aug. 6, 2020

(54) OPENNESS COUNT AND PARTICIPANT DENSITY ALGORITHM

(71) Applicant: Wide Open Tee, LLC, Sheridan, WY (US)

(72) Inventors: Steven Tyler New, Bartonville, TX (US); Scot Hunt, Sheridan, WY (US)

(21) Appl. No.: 16/267,181

(22) Filed: Feb. 4, 2019

(51) Int. Cl. G06Q 10/10; G06Q 10/02; G06F 16/9035; G06F 16/909

(52) U.S. Cl. CPC G06Q 10/1095; G06Q 10/02; G06F 9/542; G06F 16/909; G06F 16/9035

(57) ABSTRACT

A method disclosed assists users to schedule an appointment at a desired time and venue, given a number of open possibilities at one or more venues. This method is explained through its application aimed at assisting golf players to reserve a tee time by using possible event times at venues within the users' defined search for a particular tee time of a given time of day at each golf course. This algorithm allows a user to determine how quickly or slowly golf play may occur based on the number of golfers playing during a particular time period and consecutive and non-consecutive tee time availability. Through the user interface, nearby golf courses can be compared for the user to select a preferred tee time based on crowdedness and tee time availability. The method can be effective for bowling alleys, doctors' visits and other similar applications.

### FIELD OF THE INVENTION

The present invention relates to a novel method of objectively compare various potential venues for a desired activity. In this application, the method is disclosed as applied to golf players choosing tee times and comparing various golf courses to determine which of them is most likely to provide a pleasurable golfing experience by reporting the number of open tee times around a desired tee time, which allows a player to predict how quickly or slowly he can expect play to progress, based on the number of golfers playing during a defined time and tee-time availability.

While this patent application focuses on its embodiment to assist golfers select a tee time, the application can be employed to assist individuals seeking to schedule an appointment in any application where one or more venue have distinct appointment times, whether it is an airplane flight seat, a bowling lane at a bowling alley, a dinner at a reservations-only restaurant, or a dentists' office.

### BACKGROUND

Dedicated golf players can struggle to decide when and where to play a game of golf when they are in unfamiliar areas, and consistently seek ever easier methods of choosing a venue, time and date to reserve a particular tee time at a golf course. A tee time is the reserved start time for a round of golf. Tee-time reservations allow for smooth and timely transitioning between parties playing on the golf course. Tee times can be made for individuals or groups and are available anywhere from days to months in advance, depending on the course. Various third-party online websites and software applications offer a tee time marketplace to search and book tee times, or tee time reservations can be directly made with a particular golf course. Reserving a tee time entails booking any of the available starting times for players and corresponding prices for given times.

While existing software and programs allow golfers to book a tee time, current applications do not take into account how many other golfers will be on the course, which is herein described as “crowdedness”. Many golfers may find themselves to reserve a tee time at a golf course but still end up waiting on others due to golfer traffic during peak hours which diminishes the golfer's experience. If a golfer is moving quickly and finishes a hole faster than those playing ahead of him, he will wind up waiting on the group of golfers ahead of him, which can make all parties concerned uncomfortable.

Tee times are important because they keep the all of the players moving through course smoothly. If tee time reservation methods reported a crowdedness level for a course or the amount of traffic for a given time of day for a golf course, individual golfers could reserve tee times while also considering how busy a golf course will be in order to have the best golfing experience for their preferred tee time.

### SUMMARY OF THE INVENTION

Herein disclosed is a new method and application to advise and assist individuals seeking to choose an appointment or time slot at a venue such that the individual will be less likely to experience a crowded venue, both choosing a time for the activity and a venue for that activity. While this embodiment of the invention assists golfers to pick courses and times in a geographic area, the invention is not limited to golf, but also to bowling, movie seating, and myriad other activities.

Generally, the method counts the number of open positions at a desired time, and counts the open positions at that time, and the open positions not currently filled in nearby potential times. The invention is applicable in the digital space where a method of collecting and reporting customer flows be manipulate known algorithmic variables to detect a rhythm of which to effectively predict levels of openness versus crowdedness.

Specifically, the described application helps golfers reserve a tee time by using specific sequential data within their user-defined geographic area to generate an “Openness Count” and “Participant Density” for a particular tee time of a given time of day at each golf course. “Openness Count” computes consecutive open player slots and “Participant Density” is based on adding up all available tee times. The algorithm allows a user to determine how quickly or slowly golf play may occur based on the number of golfers playing during a particular period (usually 40 minutes, but not always) and consecutive and non-consecutive tee time availability. Through the user interface, nearby golf courses can be compared by users to select a preferred tee time based on crowdedness and tee time availability.

The algorithm allows the application to list and display the different golf courses based on openness and gives priority to those courses that are the most open. The algorithms results will display the courses in ranking order from highest to lowest by openness count. The highest being the most open, which will be displayed singularly for user on the MAP view. Once scrolled down, user will see the additional course results in descending order of openness count. The associated color count will be displayed beside course picture to represent its openness color.

In this application, the invention may be referred to as “the application” or “the method”.

### BRIEF DESCRIPTION OF THE DRAWINGS

FIG. 1 illustrates an example of a splash screen used as the application loads.

FIGS. 2A-2D show examples of introductory screens displayed immediately after the application loads.

FIG. 3A illustrates an example of the application login page.

FIG. 3B illustrates an example of a password recovery page.

FIG. 3C illustrates an example of the application's sign up page.

FIG. 3D illustrates an example of a verification page used by the application to ensure security.

FIG. 4 illustrates an example of the Wide Open Search input screen in which users provide desired search criteria.

FIG. 5 illustrates an example of an initial report map of golf courses close to the user-set geographic home.

FIG. 6 illustrates the Golf Course Tool Tip for the initial report map.

FIG. 7 illustrates the “NEAR BY GOLF CLUBS” report generated by the Golf Course Tool Tip.

FIG. 8 illustrates an example of the results of a screen for golf courses.

FIG. 9 illustrates an example of a menu for a typical account profile screen for the application user.

FIG. 10 illustrates the details page of a chosen golf course.

FIG. 11 illustrates a confirmation screen for a user to view the details of a golf course tee time purchase.

FIG. 12 illustrates a page featuring past bookings for a user.

FIG. 13 illustrates a page featuring scheduled tee time bookings for a user.

FIG. 14 illustrates a page featuring details of a scheduled tee time.

FIG. 15 illustrates a page used to provide comments to the application service provider.

FIG. 16 illustrates shows a list of a user's golf courses saved for convenience.

FIG. 17 illustrates a configuration page for search settings.

FIG. 18 illustrates a flow chart of the general operation of the application.

FIG. 19 illustrates a flow chart of the method of the Openness Count algorithm.

FIG. 20 shows the color scale for Openness Count.

### DETAILED DESCRIPTION OF THE INVENTION

Golf reservation systems may facilitate reserving tee-times for customers desiring to golf at a particular course at a particular time. Often, reservation of a tee-time may be made online over a wide area network such as the Internet. While tee-time requests and booking online may be relatively straightforward if the user knows which course and tee time are desired, booking a tee time does not communicate how crowded the golf course will be near the booked start tee time. A service and method processing such information to more than one golf course may face challenges in providing the information to the user in an accurate, timely, and efficient manner.

Individuals that wish to reserve a golf start tee time can book a tee time online or through the golf course. While reservation pricing on tee times depends on time of day, season, and day of the week, crowdedness is not taken into consideration. Individuals may book a tee time at a local golf course for a reasonable price but arrive to a very crowded golf course which can inconvenience and diminish the golfing experience.

The present invention can be used to reserve tee times online while showing how open that golf course will be near tee time. The present embodiment also compares golf courses openness at the requested start tee time to see if there are other courses that are more open during that time. The present software application allows players to reserve tee times while computing and showing “Openness Count” and “Participant Density.” This process allows for individuals to know how crowded a golf course will be around their chosen tee time to determine how quickly or slowly golf play may occur.

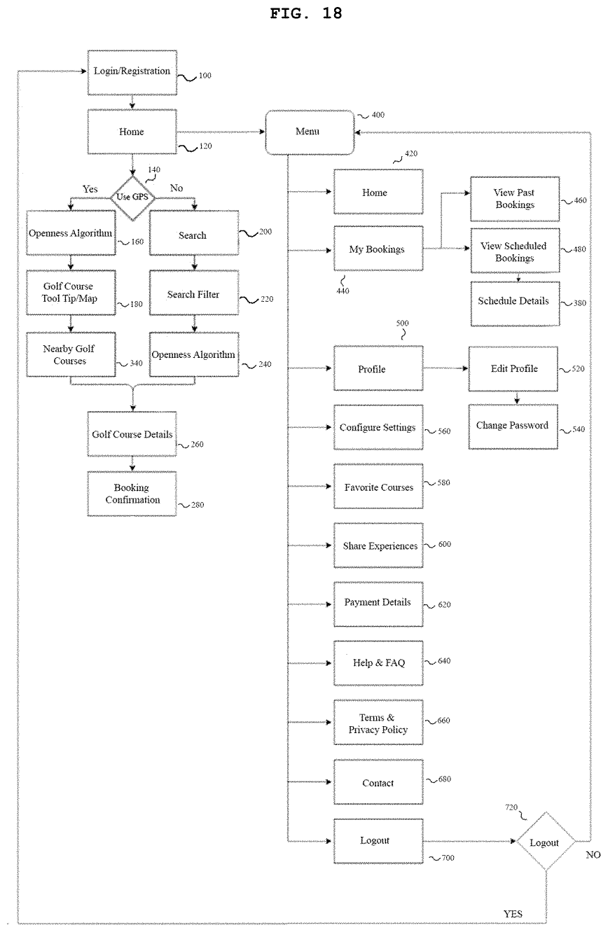

FIG. 18 is an embodiment of the application flow chart that comprises the order and process of consecutive available selections within the application in accordance with various embodiments of the present invention. A description of the elements of the flow chart follows:

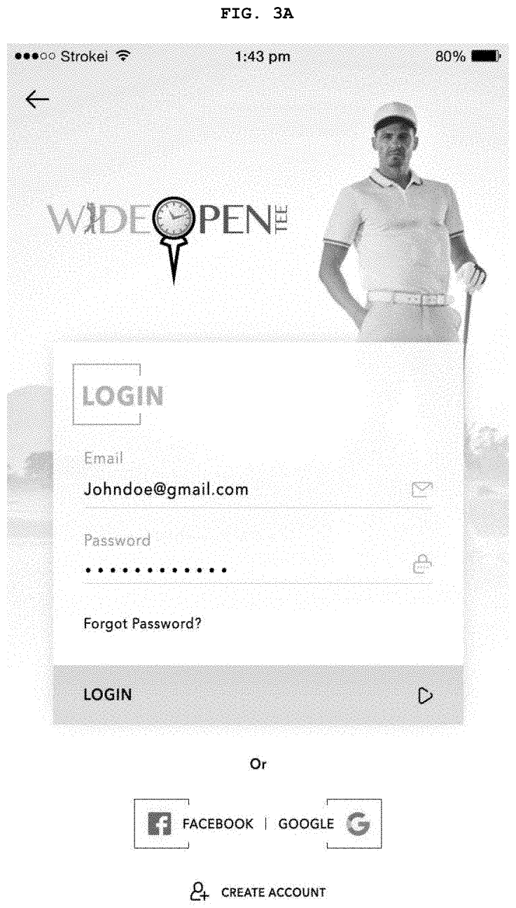

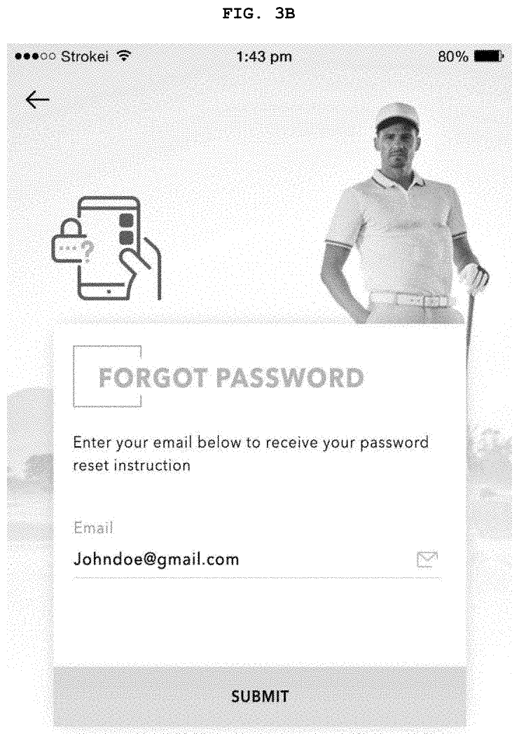

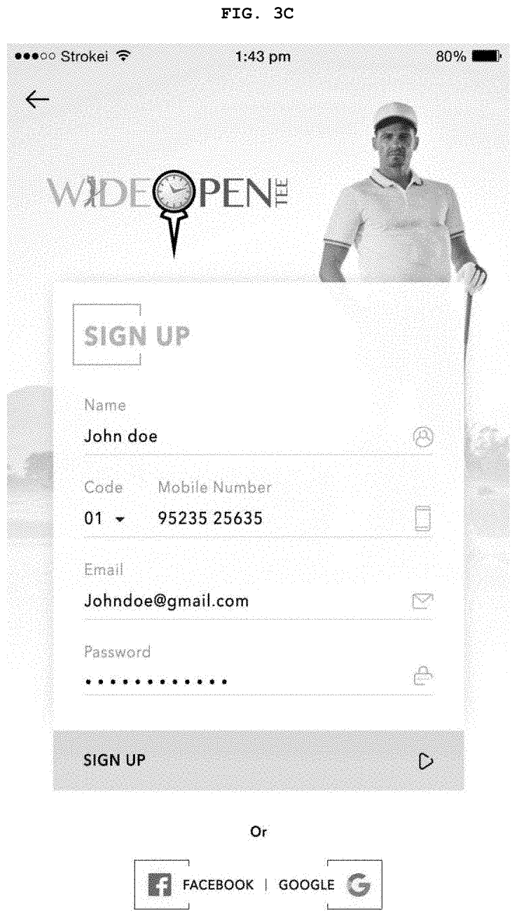

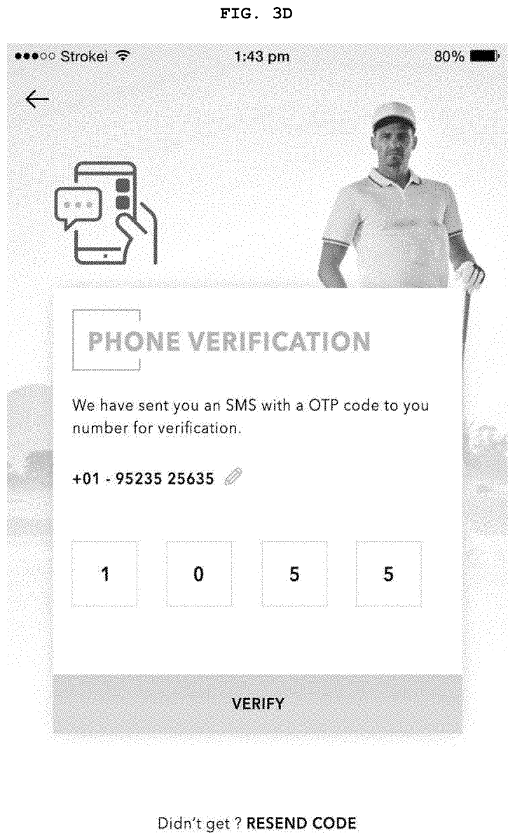

100: A user employing the method will first log into the application as shown on FIGS. 3A and 18. The method uses conventional log-in, registration, and lost password techniques common to software use.

120: After logging in, a user has the option of performing a search for golf courses or go to a menu page to perform account maintenance, or log out.

140: In the example embodiment shown on FIG. 18, users can choose to use a cell phone location as the center of a geographic search for golf courses, or enter a geographic location by hand into the application.

160: When a user allows the application to use the GPS location, the application uses a default time or a desired time is entered by hand to begin a round of golf, and the algorithm performs the Openness Algorithm to calculate the Participant Density (both further described below).

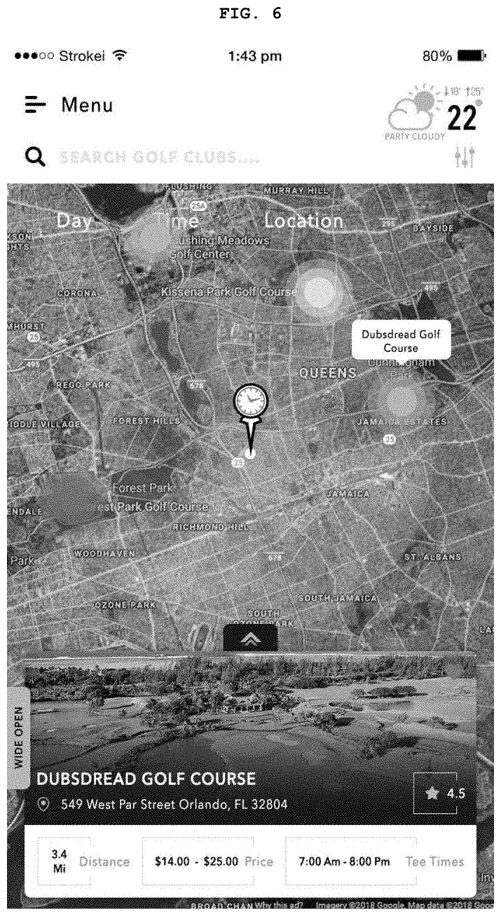

180: After performing the Openness Algorithm, the user is informed of the resulting Participant Density on the Tooltip screen, as shown on FIG. 6.

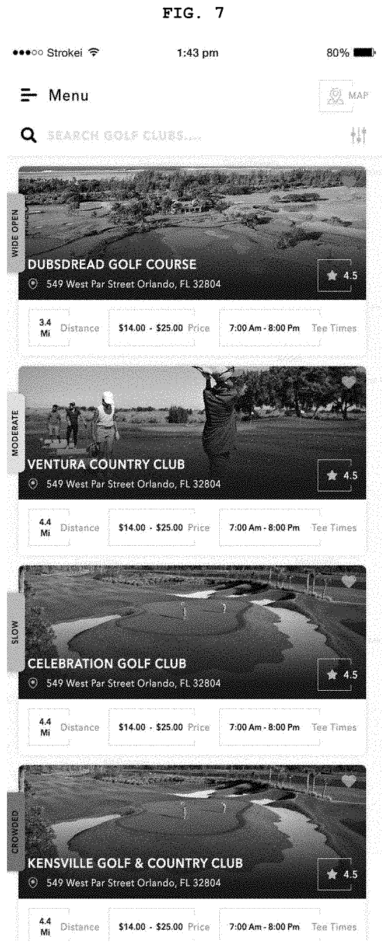

340: After examination of the initial Participant Density, viewed by a color coding of golf courses within a default range of the cell phone location, a player may choose to look at a list of nearby golf courses, as shown on FIG. 7.

200: If a user does not allow the application to use the GPS location, the user must enter or search for specific golf courses to find and book a tee time.

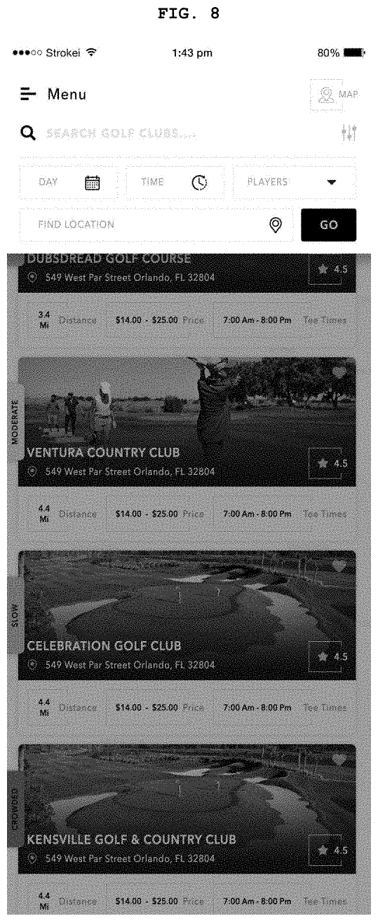

220: The user can enter desired search criteria using the search filter to find specific golf courses and tee times, one embodiment is shown in FIG. 8.

240: When a user does not allow the application to use the GPS location and the user searches for a tee time or golf, the application uses a default time or the entered desired time to begin a round of golf, and the algorithm performs the Openness Algorithm to calculate the Participant Density (both further described below) to compare the courses which were returned from the search filter results from step 220.

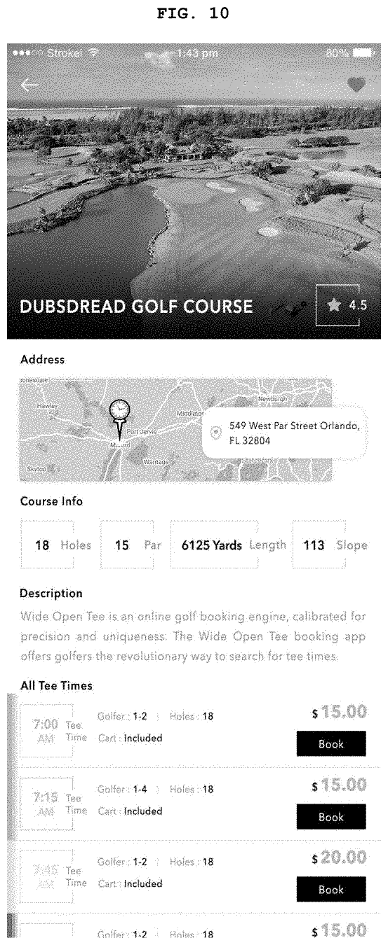

260: After selecting a golf course, the application will bring the user to golf course details page, as shown in FIG. 10. The current embodiment allows the user to view location, course information, course description and all tee times available for purchase which may or may not have received a favorable Participant Density.

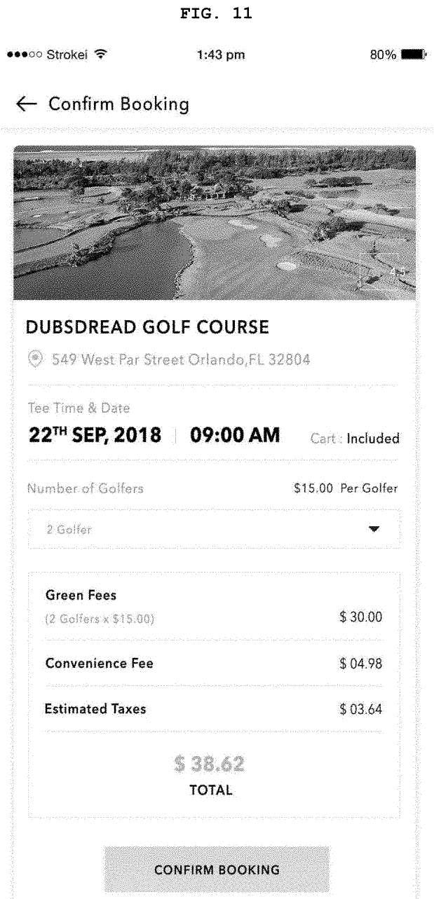

280: A user may reserve a tee time from his chosen golf course. Once the golf course is chosen and the tee time is selected, a confirmation page will show the golf course, associated tee time, information, and fees. The user can then look over the information to confirm their preferences and purchase the tee time reservation, e.g., FIG. 11.

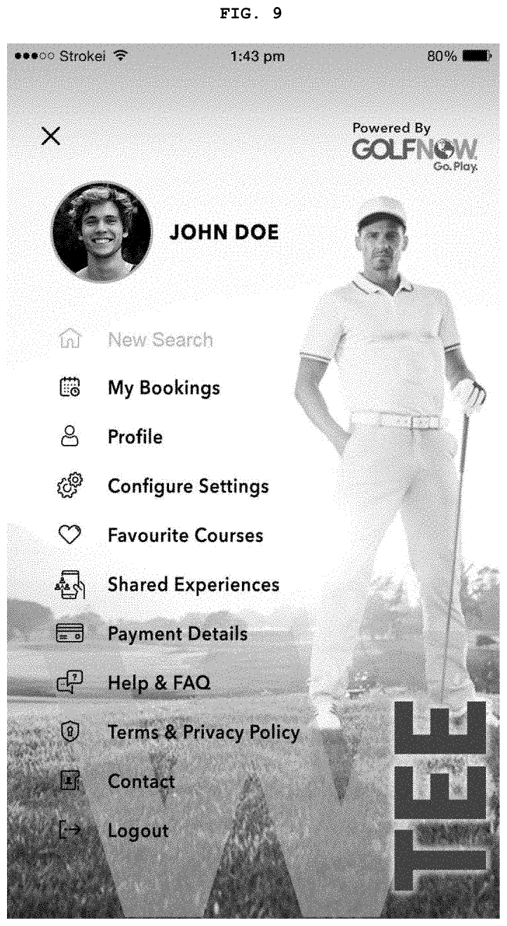

400: The user can access other application components and user or application settings through the menu page, an example embodiment can be found on FIG. 9. The present embodiment shows several of these accessible selections and options, such as “New Search”, “My Bookings”, “Profile”, “Configure Settings”, “Favorite Courses”, “Shared Experiences”, “Payment Details”, “Help & FAQ”, “Terms & Privacy Policy”, “Contact”, and “Logout”.

420: If the user selects the “New Search” component on the menu, the user will be able to conduct a new search for a golf course or tee time, effectively starting over as discussed in step 120.

440: If the user selects the “My Bookings” component on the menu, the user will be able to view and access the “Past Bookings” page and the “Scheduled Bookings” page.

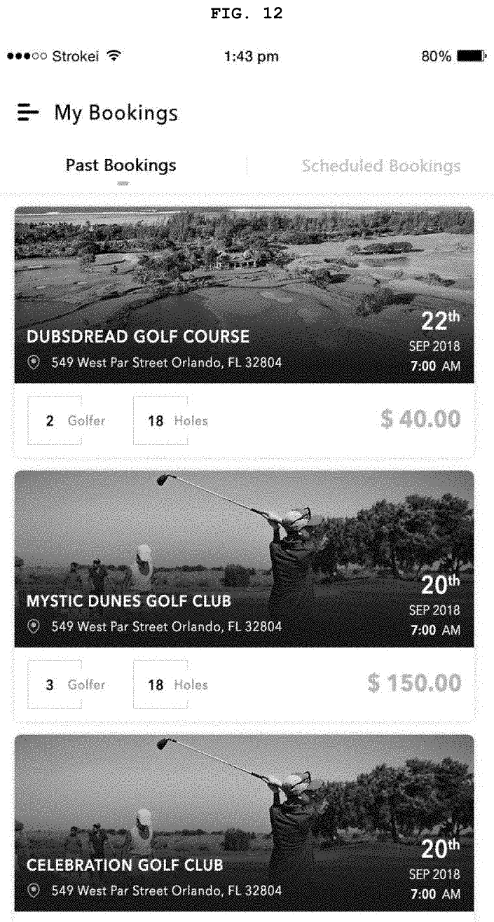

460: If the user selects the “Past Bookings” page from the “My Bookings” component, the user will view previously booked and completed golf sessions and corresponding tee times, golf courses, prices, and other relevant information, an example embodiment is shown on FIG. 12.

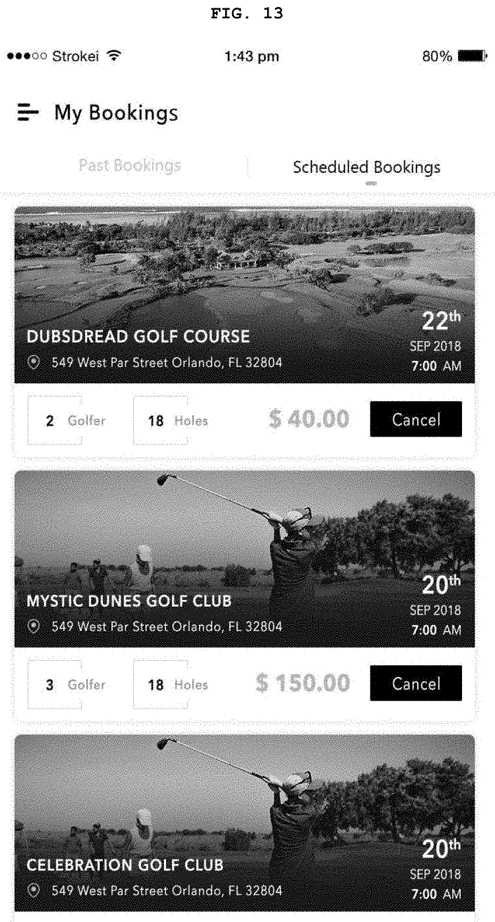

480: If the user selects the “Scheduled Bookings” page from the “My Bookings” component, the user will view the user's current purchased reserved golf sessions and corresponding tee times, golf courses, prices, and other relevant information, an example embodiment is shown on FIG. 13.

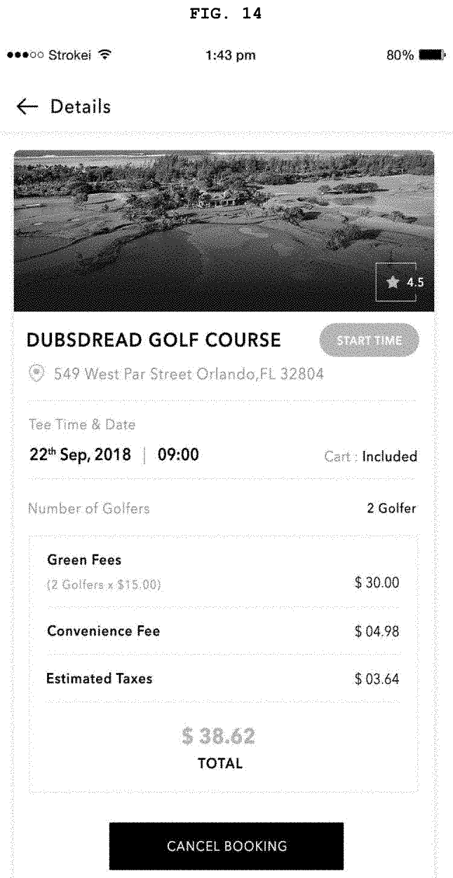

380: If the user selects a uncompleted reserved golf session on the “Scheduled Bookings” page from the “My Bookings” component, the application will bring the user to a details page for that session as shown in FIG. 14. The user can view the golf course information, tee time and date, and various fees paid for the reservation, and an option to cancel the booking.

500: If a user selects the “Profile” component on the menu, the application will take the user to their individual profile where the user can view their personal information, such as name, email, and phone number.

520: If the user is on the application's “Profile” component, the user can use the “Edit Profile” component to change their personal information, such as name, email, phone number, and password.

540: The user can change their password using the application's “Change Password” component on the “Edit Profile” component.

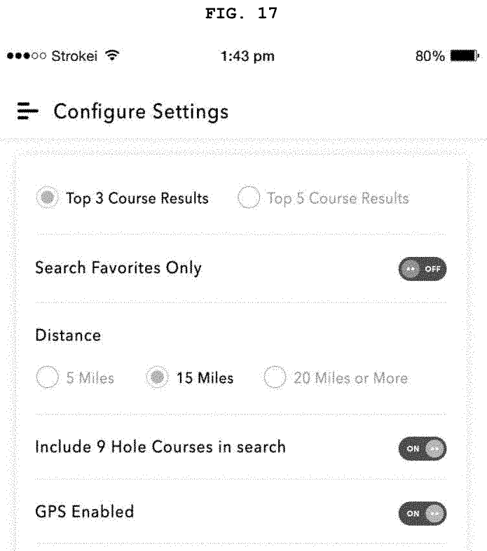

560: If the user selects the “Configure Settings” component on the menu, the user will be able to change application settings, an example embodiment is shown on FIG. 17. The user can change general application settings and change settings for the search criteria for the search component of the application.

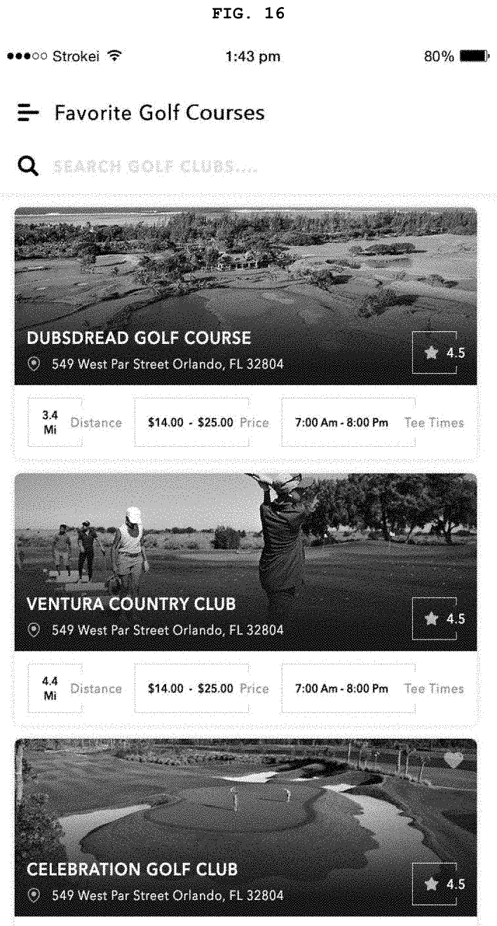

580: If the user selects the “Favorite Courses” component on the menu, the application will show the user's saved golf sessions as the user's “Favorite Golf Courses”. The saved golf sessions show the corresponding tee time, price, and distance, the example embodiment is shown on FIG. 16. The saved golf sessions can be selected for the user to conveniently rebook that particular golf session at the corresponding tee time and golf course.

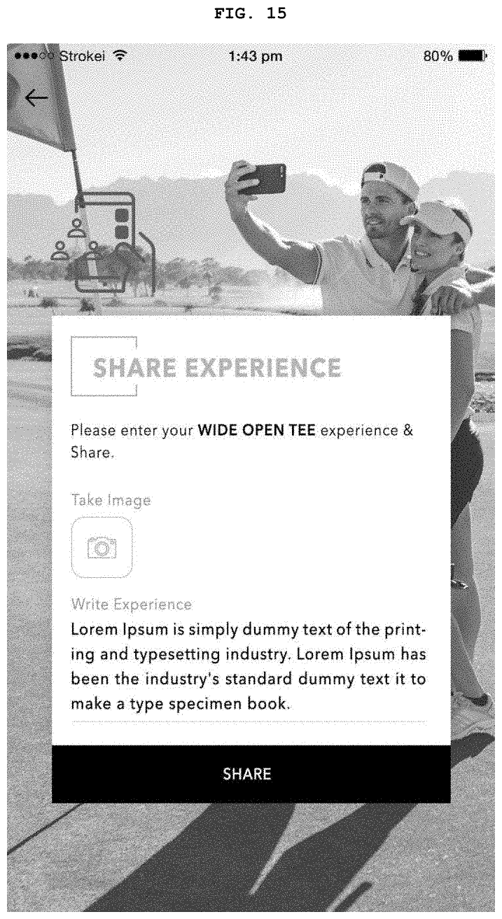

600: If the user selects the “Share Experiences” component on the menu, the application brings the user to a page where the user can share an image or a written statement on other various connected platforms such as social medias, an embodiment of the page is shown on FIG. 15.

620: If the user selects the “Payment Details” component on the menu, a page where the user can enter their preferred payment method information, such as credit card information, that will be used to purchase and reserve tee times.

640: If the user selects the “Help & FAQ” component on the menu, the application will show a page displaying various resources and information to help the user and frequently asked questions.

660: If the user selects the “Terms & Privacy Policy” component on the menu, the application will show a page displaying the application's terms of service and privacy policy for the user to review.

680: If the user selects the “Contact” component on the menu, the application will show a page displaying contact information for the application's owner.

700: If the user selects the “Logout” component on the menu, the application will display a logout confirmation page.

720: The user can choose to logout of the application and be brought back to the Login/Registration page or choose not to log out and be brought to the application menu.

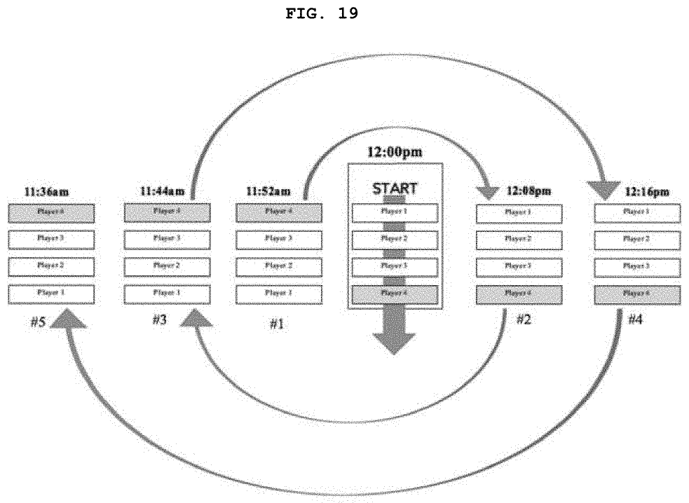

An example of the process of the openness algorithm 240 is shown in the diagram on FIG. 19 and is described herein:

Step 1. The algorithm fetches the schedule of tee times at venues located near the user or specifically selected venues by the user. The algorithm then begins fetching courses with tee time availability at requested start time (12:00 pm in diagram on FIG. 19), or optionally at a tee time within a user-defined time range. The openness algorithm also searches for the scheduled tee times immediately before and after the requested time as alternative tee start times, irrespective of whether any positions are open for those times.

Step 2. Count the number of available player slots (up to four in a traditional round of golf) at the start time.

Step 3. If there are fewer than four player slots available, stop the openness count and give the total number of available player slots to represent the openness count.

Step 4. If four player slots are available at requested start time, the algorithm will proceed fetching the tee time which immediately preceding the requested tee time, as shown on FIG. 19, and count the available player slots at that tee time. Stop the openness count if there is less than four, then add total number of open player slots available between start time and stopping point.

Step 5. If four available player slots are detected at tee box #1 (the tee time which immediately precedes the requested start time, proceed to tee box #2 (as shown on FIG. 19), which immediately follows the requested start time. If fewer than four player slots are available, the openness count is increased by the number of open player slots, and the count is completed; if four slots are available, then the count is increased by four, and the openness algorithm 240 will continue fetching to tee time #3.

The algorithm continues this looping process as illustrated until a tee time with fewer than four open slots are available, or a user-set default maximum number of open slots is reached. The current embodiment uses 24 as the maximum, as shown in FIG. 19, which reflects four open player positions at a desired start time, and four open positions at the three tee times immediately prior to the desired start time, and four open player positions at the two tee times which follow the desired start time. The algorithm stops counting open positions at the point where it finds a tee time that has less than four open positions, and that count is reported as the “Openness Count.”

In addition to computing the Openness Count based upon tee time availability, the openness algorithm 240 also calculates the “Participant Density” of a given time of day at each golf course. This allows a player to determine how quickly or slowly golf play may occur based on the number of golfers playing during a particular 40-minute period, assuming eight-minutes between tee times.

The openness algorithm 240 autonomously computes the Participant Density Factor for a 40-minute period around the requested start time, providing the results to the player to aid in the assessment of a given Start Time for its quality of play. While the Openness Count computes consecutive open player slots, this calculus adds up all available tee times, both consecutive and non-consecutive, around the requested start time.

This method without modification may misreport openness of a golf course because the algorithm runs past the edge of regular tee times because the desired start time is close to the beginning or end of a day. For example, at the beginning of a day, the course is empty and cannot be more open, but the algorithm described above will result in an openness count of four, because the immediately preceding tee time does not exist. The algorithm may account for this inherently by assuming that, if a next scheduled tee time does not exist on a golf course's regular schedule, the method assumes the course as completely open by adding a full count of four for all non-existent tee times. This anomaly will occur at both ends of the day.

Similarly, the openness algorithm searches for the scheduled tee time immediately before and after the requested time as an alternative tee start time. If the requested time is the first or last tee time of the day, the choices which are beyond the scheduled tee times do not exist; though these tee times cannot be booked, they are not reported as part of the choices to a user, even if they are still used in the openness algorithm.

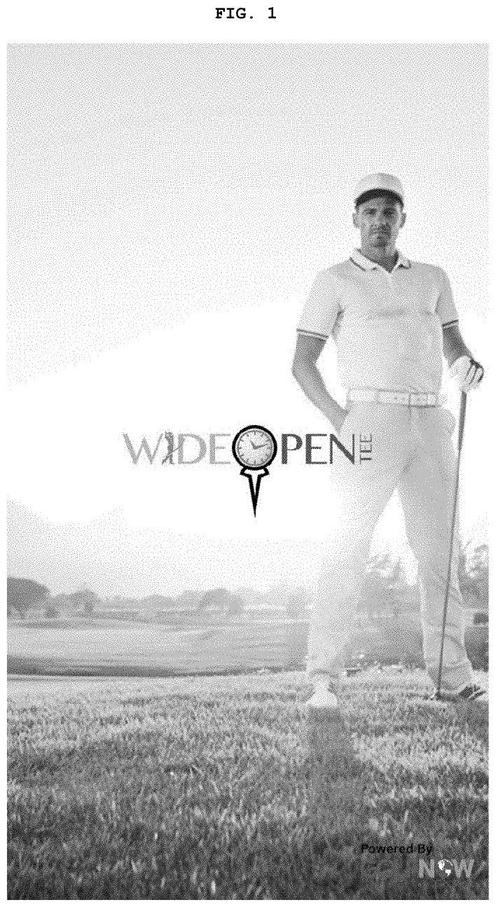

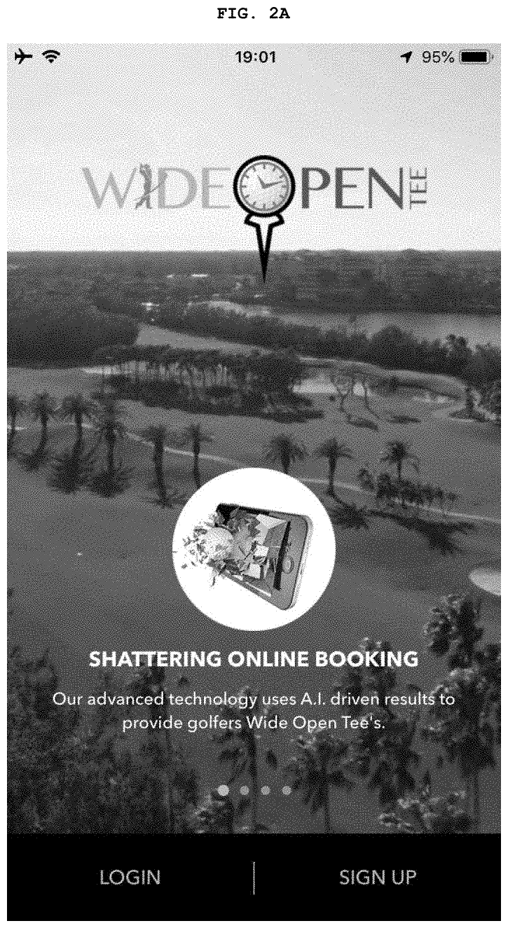

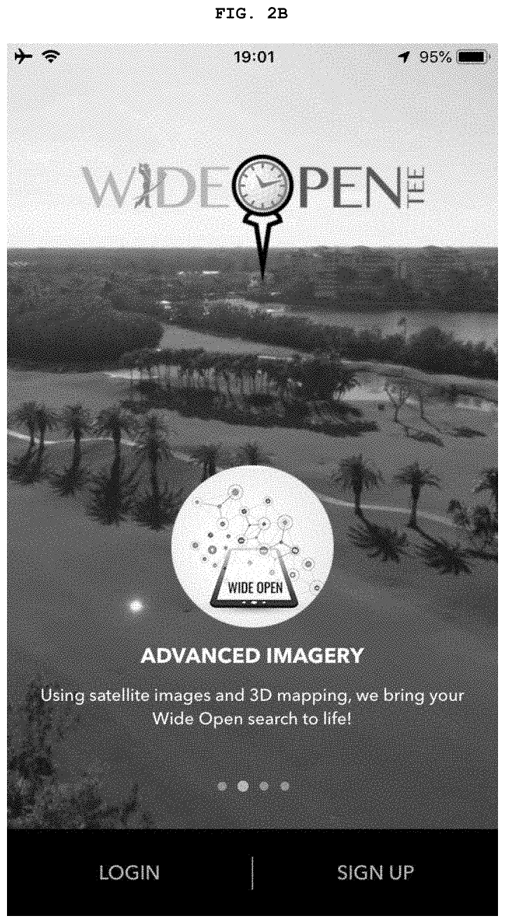

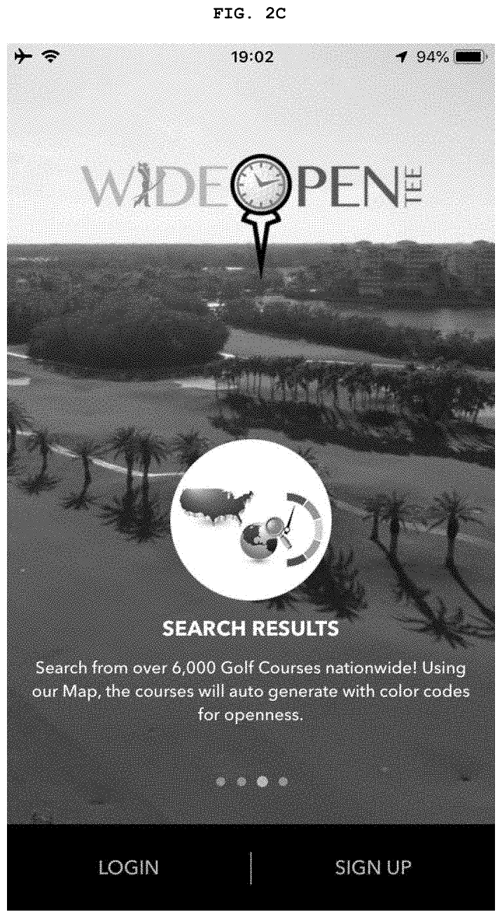

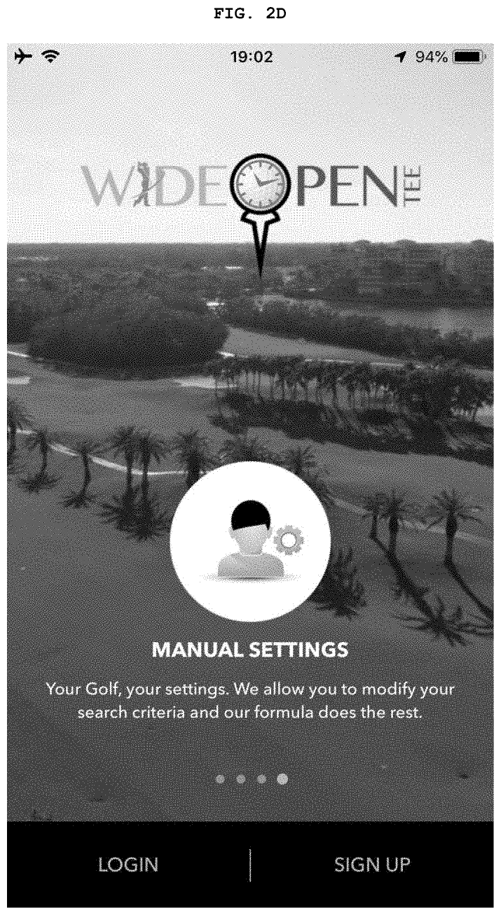

FIG. 1-3D shows a standard user login/registration process 100 for the golf application. This information allows for account security and account recovery for the application.

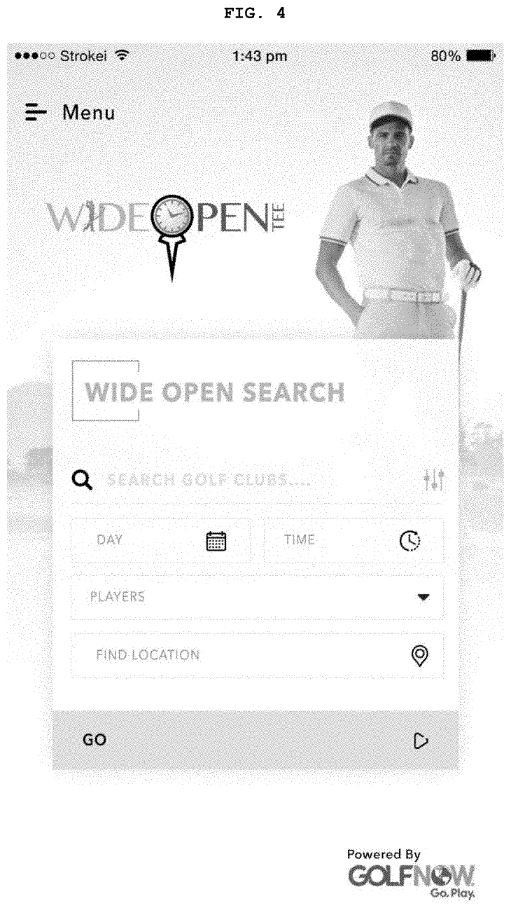

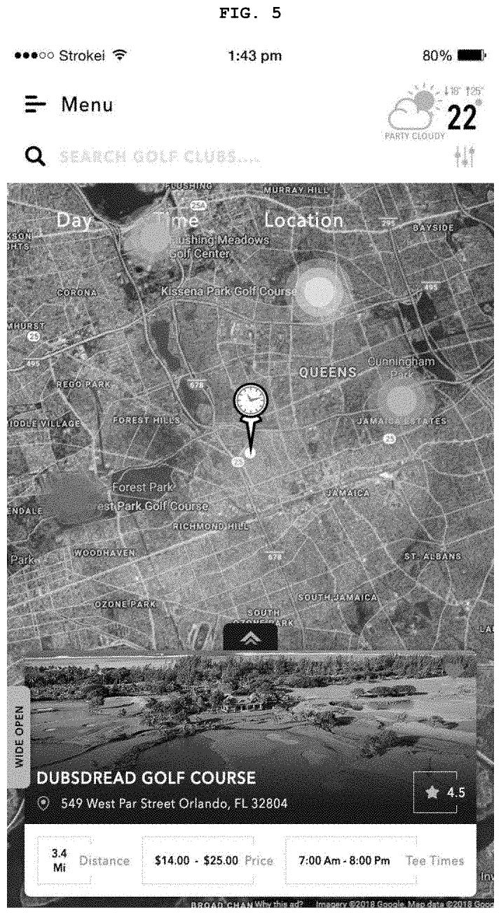

The application's home 120 page (FIG. 4) includes a search capability Non-GPS search 200 component and GPS enabled Map 180 (FIG. 5) which displays the user's location and nearby golf courses location with the implemented map Golf Course Tooltip 180 (FIG. 6).

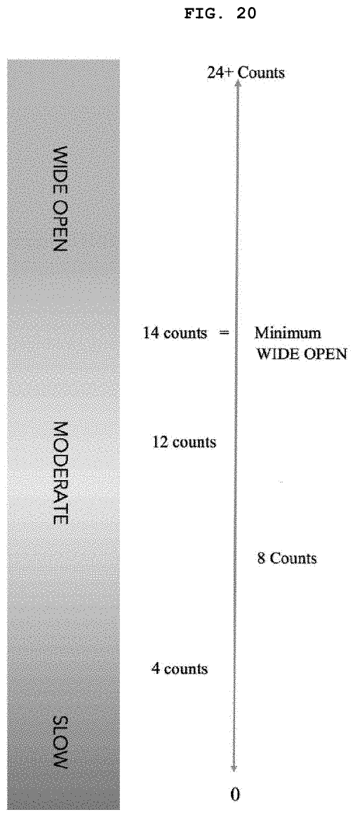

FIG. 20 shows one embodiment of the color scale for openness count that is featured on the map 180 showing the various color-coded courses, with green being the most open (highest counts of openness), to yellow which is moderately open, to orange-red which is slow (lowest counts of openness). The openness algorithm 160 calculates openness counts to measure crowdedness around the selected tee time and the corresponding ranking of openness is shown by the different colors on each golf course, as shown on a map 180 or golf course details 260, giving the most priority to more open courses with the highest openness count.

When users do not want to use the GPS component 140, they can use the Non-GPS search 200 component (FIG. 7) with included search filter 220 (FIG. 8) for the user to enter and find specific tee times or golf courses with corresponding openness, prices, and tee times through the openness algorithm 240. The results lead the user to the view golf course details 260 and nearby golf courses 340 can be viewed on the map 180.

As shown in FIG. 10, when the user selects a golf course from the results of the non-GPS search 200 or the map 180 a golf course details screen 260 provides information about the specified golf course, such as the address of the golf course, course information (how many holes, par, total length of the course, slope), a description of the course, and all tee times available for purchase with corresponding openness levels, number of people, start time, and price.

When user find and select a preferred tee time at a specified golf course which they would like to purchase, they encounter a booking confirmation screen 280 that comprises the prices, fees, and taxes for the purchase and the amount of golfers booked with the specified date, time and location where they can confirm their purchase. (FIG. 11) The transaction charges the users' preferred payment method with user's given payment details 620.

FIG. 9 shows the menu page 400 where a variety of features can be selected to view personalized information or other user resources. The menu page 400 comprises a My Bookings page 440, profile page 500, configure settings page 560, favorite courses page 580, share experiences 600 page, payment details page 620, Help & FAQ page 640, Terms & Privacy Policy page 660, a contact page 680, and a logout component 700 and logout action 720 that will lead a user back to the menu 400 if declined or log the user out if accepted.

The profile page 500 comprises information which users can edit at the edit profile screen 520 and there access and change their password with the change password screen 540. The applications settings can be changed through the configure settings screen 560 for such search parameters as distance to course, number of courses, restrict to favorite courses only, and enabling or disabling GPS, as shown in FIG. 17.

FIG. 16 shows an embodiment of a screen where users can save certain courses and tee times as their favorite courses 580 for convenient booking of tee times.

FIG. 12 shows an embodiment of the application's My Bookings page 440, where users can view the totality of their past bookings 460 and scheduled bookings 480.

FIG. 13 shows a screen used in the current embodiment that shows users' past bookings 460, and can completed tee times with their courses, prices paid, and number of golfers for that completed booking.

FIG. 14 shows an embodiment of the Scheduled Bookings Screen 480 which can include a user's purchased tee times that are uncompleted and booked with their courses, prices, number of golfers and holes. The user can see the schedule details 380 of each purchased scheduled tee time and have the option to cancel the booked tee time.

FIG. 15 shows an embodiment of a Share Experience screen 600, which allows a user to review and share experiences concerning a golf course.

The method is not restricted to golf as described in this embodiment, but can be applied to many different industries. For example, restaurants could use the method to attract customers with shorter wait times. There are many popular streets in entertainment districts with many competing restaurants that are in close proximity of one another. These restaurants have different sizes with different numbers of tables for their customers, some restaurants have longer wait times than others during peak hours. If the method was implemented into the restaurant industry, restaurants could convey the number of open tables they have at any given time, and openness can be reported as a ratio of open tables to total tables, with color-coding of restaurants with open seats, or simply a reported expected wait time for a given size of table.

Movie theatres may also implement this method. Movie theatres need to fill their theatres with as many customers as possible. Whenever a showing is full the showing could report as sold out, or given a movie, size of party, or desired start time, the application could report how crowded the theater is at the time, or suggest theaters that can sell advance tickets complying with the desires of the users. If movie theatres were able to implement an embodiment of this method then competing theatres could convey crowdedness level for different showings throughout the day, and users could compare the theatres for their preferred showing.

Ski resort lift ticket booking is also another application, as a would-be skier can evaluate how crowded a particular set of ski runs will be by using the application to track how crowded the run is, given a lift ticket and day, and time if applicable.

Competing local offices and business that offer services like law firms, orthodontists, and hair stylists could also use an embodiment of this method to suggest times.

Lastly, the method described can be directed to automatically send emails, texts, or even phone alerts to significant changes in an openness count after a user has booked an appointment. In such operation, the method can automatically repeat the openness count daily on all previous uses that resulted in a booked event, and send an alert using email, text, or other means to a user of a change in the color-coded category to indicate a substantial change in the openness of a chosen venue or alternate venue that was part of the algorithm search results, such alert occurring automatically based on a user-determined default schedule, or by a direct request of a user.

### Miscellaneous Notes

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the above detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, this description is not to be taken in a limiting sense, and the scope of embodiments in accordance with the present invention is defined by the claims and their equivalents.

As used herein, reference to a “component” may refer to hardware, software, or firmware components employed to obtain a desired outcome. Although only a given number of discrete components may be illustrated or described, such components may nonetheless be represented by additional components or fewer components without departing from the spirit and scope of embodiments of the invention.

Various operations may be described as multiple discrete operations in turn, in a manner that may be helpful in understanding embodiments of the present invention; however, the order of description should not be construed to imply that these operations are order dependent.

The terminology used herein is for the purpose of describing particular embodiments only and is not intended to be limiting of the invention. Such phrases as “in an embodiment” and “in embodiments” refer to one or more of the same or different embodiments. The terms “comprising,” “including,” “having”, and the like, are synonymous. The term “and/or” includes any and all combinations of one or more of the associated listed items. The singular forms “a”, “an”, and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Although certain embodiments have been illustrated and described herein for purposes of description of some embodiments, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

A legend of the components discussed in the application and shown in the drawings is as follows:
Login/Registration 100,
Home 120,
GPS component 140,
Openness algorithm 160,
Golf Course Tool Tip/Map 180,
Nearby Golf Courses 340,
Search 200
Search Filter 220,
Golf Course Details 260,
Booking Confirmation 280,
Schedule Details 380,
Menu 400,
New Search 420,
My Bookings 440,
View Past 460,
View Scheduled Bookings 480,
Profile 500,
Edit Profile 520,
Change Password 540,
Configure Settings 560,
Favorite Courses 580,
Share Experience 600,
Payment Details 620,
Help & FAQ 640,
Terms and Privacy Policy 660,
Contact 680,
Logout 700
Logout action 720

The inventor claims:

1. A method for selecting an appointment time and location for an event, comprising:
a. Determining a geographic location about which to search for a venue to hold an event;
b. Choosing a maximum distance from the geographic location to establish a radius to conduct a search;
c. Choosing a desired time for the event;
d. Creating a list of potential venues within the user-set radius of the geographic location;
e. Obtaining the list of regularly scheduled appointment positions and set of open appointment positions for each venue on the list;
f. Counting the number of open appointment positions at each venue on the list at the regularly scheduled appointment time closest to the desired time for the event, from a known set of regularly scheduled appointment times and open positions at those times reported by each venue;
g. Establishing a number of regularly scheduled appointment times to search for open appointment positions which immediately preceding the closest regularly scheduled appointment time and a second number of regularly scheduled appointment times to search for open appointment times which immediately follow the closest regularly scheduled appointment time.
h. Adding to the previous count the number of open appointment positions at each venue on the list at the previously established number of appointment times which immediately precede the closest regularly scheduled appointment time.
i. Adding to the previous count the number of open appointment positions at each venue on the list at the previously established number of appointment times which immediately follow the closest regularly scheduled appointment time.
j. Categorizing each venue in the list with one of several colors, in which each color indicates a range of open appointment positions as previously counted;
k. Displaying all venues within the radius of the geographic location using its categorizing color to indicate to a user how many open positions are available at each potential venue;
l. Allowing a user to select from the displayed venues and proceed to set an appointment at the chosen venues.

2. The method of claim 1, additionally comprising the limitation that the method uses the known location of a portable computing device to determine a geographic location about which to search for a venue to hold an event in step a.

3. The method of claim 1, additionally comprising the limitation that the number of immediately preceding and following regularly scheduled appointment times used to count open positions is requested from a user.

4. The method of claim 1, additionally comprising the limitation that the number of immediately preceding and following regularly scheduled appointment times used to count open positions is stored in memory and unchangeable by the user.

5. The method of claim 1 with the additional steps between step i and step j of adding to the count the number of open appointment positions that have not been counted because the regular schedule of appointment times does not start early enough to extend to the reach of the previously established number of appointment times which immediately precede the desired appointment time, and also adding the number of open appointments that have not been counted because the regular schedule of appointment times ends before the calculated reach of the previously established number of appointment times which immediately follow the desired appointment time.

6. The method of claim 1, additionally comprising the limitation that the number of immediately preceding and following regularly scheduled appointment times used to count open positions are stored as default values in memory and the user may choose to use the default values or change them as part of step f.

7. The method of claim 1, additionally comprising the following steps prior to the steps of claim 1:
a. Asking a user if he has previously used the method with a specific method provider, and registering the user to use the method by providing unique identifying information with the method provider if the user has not previously used the method with the specific method provider, such that the user can be identified using the information provided during future uses;
b. Confirming the user is a registered user by requesting identifying information provided to the specific method provider the first time the user used the method with the specific method provider.

8. The method of claim 1, with following additional step between step f and step g: Giving a user the option of saving the previously accepted user-determined number of regularly scheduled appointment times immediately preceding the desired time as a default for future uses of the method.

9. The method of claim 1, additionally comprising the limitation that the method allows a user to optionally allow the method to use the known location of a portable computing device to determine a geographic location about which to search for a venue to hold an event in step a.

10. A method for selecting an appointment time and location for an event, comprising:
a. Determining a geographic location about which to search for a venue to hold an event;
b. Choosing a maximum distance from the geographic location to establish a radius to conduct a search;
c. Choosing a desired time for the event;
d. Creating a list of potential venues within the user-set radius of the geographic location;
e. Obtaining the list of regularly scheduled appointment positions and set of open appointment positions for each venue on the list;
f. Finding a count of open positions at each venue, using the following procedure:
i. Finding the number of open appointment positions at each venue on the list at a best fit time, which is defined as the regularly scheduled appointment time closest to the desired time for the event, from the known set of regularly scheduled appointment times and open positions at those times reported by each venue, and stopping the count for any individual venue if the number of such open appointment positions at the best fit time is not four;
ii. For all venues which have a count of four, adding to each venue count the number of open appointment positions at each venue for the regularly scheduled appointment time immediately prior to the best fit time, as found from the known set of regularly scheduled appointment times and open positions at those times reported by each venue, and stopping the count for any individual venue if the number of such open appointment positions is not eight;
iii. For all venues which have a count of eight, adding to each venue count the number of open appointment positions at each venue for the regularly scheduled appointment time immediately following the best fit time, as found from the known set of regularly scheduled appointment times and open positions at those times reported by each venue, and stopping the count for any individual venue if the number of such open appointment positions is not twelve;
iv. For all venues which have a count of twelve, adding to each venue count the number of open appointment positions at each venue for the regularly scheduled appointment time that is the second earlier appointment time before the best fit time, as found from the known set of regularly scheduled appointment times and open positions at those times reported by each venue, and stopping the count for any individual venue if the number of such open appointment positions is not 16.
v. For all venues which have a count of 16, adding to each venue count the number of open appointment positions at each venue for the regularly scheduled appointment time that is the second later appointment time before the best fit time, as found from the known set of regularly scheduled appointment times and open positions at those times reported by each venue, and stopping the count for any individual venue if the number of such open appointment positions is not 20.
vi. For all venues which have a count of 20, adding to each venue count the number of open appointment positions at each venue for the regularly scheduled appointment time that is the third earlier appointment time before the best fit time, as found from the known set of regularly scheduled appointment times and open positions at those times reported by each venue, and stopping the count at all venues.
g. Categorizing each venue in the list with one of several colors, in which each color indicates a range of open appointment positions as previously counted;
h. Displaying all venues within the radius of the geographic location using its categorizing color to indicate to a user how many open positions are available at each potential venue;
i. Allowing a user to select from the displayed venues and proceed to set an appointment at the chosen venues.
j. and proceed to set an appointment at the chosen venues

11. The method of claim 10, additionally including in step ii to step iv the limitation of adding four to the count and continuing the counting process if no open positions are available at the examined venue and appointment time because the venue is closed and no regularly schedule appointment is available.

12. The method of claim 1, with the additional feature of sending an alert using email, text, or other means to a user of a change in the color-coded category indicating openness of a chosen venue or alternate venue that was part of the openness count, such alert occurring automatically based on a user-determined default, or by a direct request of a user.

13. The method of claim 1 as applied to movie theaters, in which the number of appointment positions at each scheduled appointment time is equal to the number of seats in the theaters found in the search.

14. The method of claim 1 as applied to airline flight selection, in which the geographic location is a known flight path from one metropolitan area to another, the maximum distance and search seeks to find all of the flights on a given day matching that flight plan, and the number of appointment positions at each scheduled appointment time is equal to the number of seats in each potential flight located during a search.
